(19) United States
(12) Patent Application Publication
(10) Pub. No.: US 2008/0105677 A1
(43) Pub. Date: May 8, 2008

(54) METHODS FOR PRODUCING A CONTAINER HAVING A SUBSTANTIALLY TWO DIMENSIONAL IMAGE ON A SURFACE HAVING A TOPOGRAPHICAL TEXTURE, AND A CONTAINER BEARING SUCH AN IMAGE

(75) Inventors: Harvey Kalef, Richmond Hill (CA); Alan Litwack, (US); Wayne Ernest Conrad, Hampton (CA); Nina Kanevsky Conrad, Hampton (CA); Helmut Horst G. Conrad, Hampton (CA); Ron Hills, Hampton (CA)

Correspondence Address: BERESKIN AND PARR, 40 KING STREET WEST, BOX 401, TORONTO, ON, M5H 3Y2, omitted

(73) Assignee: 2089275 ONTARIO LTD., Richmond Hill, ON (CA)

(21) Appl. No.: 11/774,792

(22) Filed: Jul. 9, 2007

Related U.S. Application Data
(63) Continuation-in-part of application No. 11/571,317.
Application No. 11/571,317 is a continuation-in-part of application No. 11/571,300.
Application No. 11/571,300 is a continuation-in-part of application No. 11/571,323.
(60) Provisional application No. 60/610,170, filed on Sep. 16, 2004.
(60) Provisional application No. 60/621,669, filed on Oct. 26, 2004.
(60) Provisional application No. 60/624,547, filed on Nov. 4, 2004.
(60) Provisional application No. 60/654,936, filed on Feb. 23, 2005.
(60) Provisional application No. 60/654,941, filed on Feb. 23, 2005.
(60) Provisional application No. 60/654,938, filed on Feb. 23, 2005.
(60) Provisional application No. 60/654,937, filed on Feb. 23, 2005.

(51) Int. Cl. B65D 6/00; B65D 43/02; B65D 43/16; B65D 51/02; B65D 85/00; B65D 30/02; B29C 41/00

(52) U.S. Cl. 220/4.01; 220/674; 206/307; 220/810; 383/105; 29/428; 264/299

(57) ABSTRACT

A container assembly comprises a plastic substrate, at least a portion of which has a textured image, the textured image comprising a substantially two-dimensional image and, a topographical texture aligned with the two dimensional image wherein the topographical texture corresponds to at least one feature of the two dimensional image. The container assembly is configured for assembly to provide a container. A method of manufacturing the container is also provided.

### RELATED APPLICATIONS

This application is a (1) continuation-in-part of U.S. Utility patent application Ser. No. 11/571,317 filed on Dec. 27, 2006, which is a national phase application of International Application No. PCT/CA2005/001415 filed Sep. 16, 2005, which claims the benefit of U.S. Provisional Patent Application No. 60/610,170 filed on Sep. 16, 2004, and (2) a continuation-in-part of U.S. Utility patent application Ser. No. 11/571,300 filed on Dec. 27, 2006, which is a national phase application of International Application No. PCT/CA2005/001578 filed on Oct. 18, 2005, and (3) a continuation-in-part of U.S. Utility patent application Ser. No. 11/571,323 filed on Dec. 27, 2006, which is a national phase application of International Application No. PCT/CA2005/001579 filed Oct. 18, 2005, which claims the benefit of U.S. Provisional Patent Application Nos. 60/621,669 filed on Oct. 26, 2004; 60/624,547 filed on Nov. 4, 2004; 60/654,936 filed on Feb. 23, 2005; 60/654,941 filed on Feb. 23, 2005; 60/654,938 filed on Feb. 23, 2005; and 60/654,937 filed on Feb. 23, 2005 the entire contents of all of which are hereby incorporated by reference.

### FIELD OF THE INVENTION

This invention relates to methods for using a deformable plastic substrate, such as polystyrene or polyvinylchloride (PVC), to produce a container, such as a gift box or bag, which has three dimensional image.

### BACKGROUND OF THE INVENTION

It is known to produce art reproductions by printing an image on a thermoformable sheet and subsequently subjecting the thermoformable sheet to vacuum molding to provide topography in the image surface thereof. See for example U.S. Pat. Nos. 5,958,470 and 5,904,962. In addition, other limited uses of artwork reproduced on a thermoformable sheet have been proposed in U.S. Pat. No. 5,904,962.

### SUMMARY OF THE INVENTION

In accordance with the instant invention, improved methods and products are provided for utilizing plastic deformable substrates. The substrate has a two-dimensional image. For example, an image may be provided on the front or image bearing face of the substrate, such as by being printed thereon. The substrate is treated, such as by being subjected to pressure and/or vacuum forming, to create a three-dimensional representation or topography corresponding to, e.g., an original piece of art, a design, an advertisement or any other desired image.

In accordance with an embodiment of the instant invention, the substrate may be incorporated into or used as packaging. For example, the substrate may be provided as part or all of the packaging of a product.

Alternately, or in addition, the substrate may be secured to all or a portion of the outside of the packaging of a product. The substrate may be at least translucent and, preferably, is transparent (i.e., is formed from a clear plastic which may have an image printed thereon and a topography provided therein). Accordingly, part of the product may be visible through the image substrate.

The packaging may be gift packaging—e.g. a gift box, e.g., a one or a two-piece box (namely a box with a removable lid) or bag. An advantage of this use of the substrate is that the box or bag has increased strength and rigidity. Therefore, the gift packaging will tend to rip less than a paper bag or cardboard box. Also, with the increased rigidity, a gift box can be reused more times.

If the packaging is a gift bag, then the substrate is preferably configured to receive portions of handles that may pierce the substrate without the substrate being deformed or pierced by the handle. Preferably to substrate is so configured by providing holes at a location where the handles will be attached to the substrate, such as by passing through the substrate. Alternately, or in addition, the substrate may be thickened at the portion where the hole is provided. These holes or openings may be configured to reduce the likelihood of stress causing a crack to occur or propagate when a gift (load) is placed in the bag and the handle used to transport that bag.

For example, holes or openings may be provided in the substrate, e.g., the upper part of opposed sidewalls of the bag, for receiving that handles. The handles may be an elongate member, e.g., a cord, rope or length of plastic, which is passed through the holes as in known in the bag art. Alternately, or in addition, the handles may be formed from a portion of the substrate that is integrally formed with the portion of the substrate that forms the portion of the bag that defines the cavity for receiving a gift or other item to be carried. Any handles known in the bag art maybe used.

Alternately or in addition, a thermoformable sheet may be incorporated into a container by associating the thermoformable sheet, which has an image and a three dimensional profile produced therein, with paper or other sheets known in the art, which are used in preparing containers (a mounting substrate). Accordingly, the mounting substrate is used to secure the image substrate into the container. For example, in one particularly preferred embodiment, the image substrate may be an advertisement or picture for a product. The mounting substrate may be a sheet of cardboard, plastic or the like. Accordingly, in accordance with this invention, it is possible to mass produce packaging which has images provided therein which are printed on thermoformable plastic and have a relief or topography provided in the thermoformable sheet (i.e. a three dimensional image). By using a mounting substrate, it is possible to incorporate three-dimensional advertisements or the like into containers using existing manufacturing techniques.

Preferably, the image substrate is attached to the mounting substrate prior to the mounting substrate being incorporated into the container. However, it will be appreciated that in an alternate embodiment, the image substrate may be affixed to the mounting substrate subsequent to the mounting substrate being incorporated into the container.

In such an embodiment, the image substrate and the mounting substrate are a composite work that together forms a “panel” or “portion” of the container. A further advantage of this aspect of the instant invention is that, by using a mounting substrate, both sides of the panel or portion may be utilized to contain articles, images or any other material routinely provides on surfaces of a container. For example, the image-bearing surface of the image substrate may have a picture, advertisement or the like provided therein. The opposite or rear surface of the image substrate contains the negative version of the topography provided in the image substrate and is accordingly less desirable for use. For example, it is less desirable to have text on the negative image side of an image substrate as the text may be difficult to read as the surface has the negative topography of the front, image, bearing surface. The side of the mounting substrate that is not affixed to the image substrate may have text, pictures or the like provided thereon. Accordingly, both sides of a “panel” or “portion” may be utilized.

The image substrate may be removably affixed to the mounting substrate, such as by a releasable adhesive, which adhesives are known in the art. Alternately, or in addition, the mounting substrate and the image substrate together may be removably affixed to the container. For example, the mounting substrate may have perforations or a score line provided therein so as to permit the mounting substrate, which has the image substrate provided thereon, to be removed or torn out of container. This particular embodiment may be utilized if the image substrate contains a coupon, poster or the like.

In accordance with the instant invention, there is provided a container assembly comprising:
(a) a plastic substrate, at least a portion of which has a textured image, the textured image comprising:
   (i) a substantially two dimensional image; and,
   (ii) a topographical texture aligned with the two dimensional image wherein the topographical texture corresponds to at least
   one feature of the two dimensional image;
wherein the container assembly is configured for assembly to provide a container.

In one embodiment, the substrate comprises a thermoformable plastic.

In another embodiment, the substrate is one or more of poly vinyl chloride, ethylene vinyl acetate, polystyrene, neoprene, polyethylene, ABS, and PET.

In another embodiment, the substrate is molded to provide the topographical texture.

In another embodiment, the substrate defines a plurality of panels that, when assembled, provide a container having a cavity.

In another embodiment, the cavity is sized to receive a storage medium case.

In another embodiment, the cavity is enclosed on all sides by the substrate.

In another embodiment, the cavity has an opening that is reversibly closeable by at least one of the panels.

In another embodiment, the container is a box having an openable lid.

In another embodiment, the container comprises a bottom container portion, and an openable lid that is removably receivable on the bottom container portion.

In another embodiment, the plurality of panels are integrally joined together.

In another embodiment, the plurality of panels are bendable about dividing lines provided in the substrate.

In another embodiment, the container is a bag.

In another embodiment, all of the container is formed from the plastic substrate.

In another embodiment, the container is a tubular container.

In another embodiment, the tubular container is a storage medium sleeve.

In another embodiment, the at least one container surface comprises an image side bearing the textured image and a reverse side and the reverse side has a backing layer affixed thereto.

In accordance with another aspect of this invention, there is provided a method for producing a container assembly comprising:

a) providing a plastic substrate having at least one container surface;

b) providing a substantially two dimensional image on the at least one container surface; and,

c) providing a topographical texture corresponding to at least one feature of the substantially two-dimensional image, such that the at least one feature of the image varies in a third dimension, orthogonal to the two dimensions of the image.

wherein the container assembly is configured for assembly to provide a container.

In one embodiment, the at least one container surface is made of a deformable material, and step (c) comprises molding the deformable material to provide the topographical texture.

In another embodiment, the method further comprises providing a substrate that is made of thermoformable plastic as the substrate.

In another embodiment, the method further comprises providing the topographical texture by molding the substrate.

In another embodiment, the substrate comprises an image side bearing the two dimensional image and a reverse side, and the method further comprises providing a backing layer on the reverse side.

### BRIEF DESCRIPTION OF THE DRAWINGS

These and other advantages of the instant invention will be more fully and completely understood in association with the following description of the preferred embodiments of the invention in which:

FIGS. 1A and 1C are perspective views and FIG. 1B is a cross sectional view, of a container in accordance with an aspect of this invention, which preferably functions as a gift box;

FIG. 1D is an enlarged view of an optional construction detail of the container of FIG. 1A;

FIG. 2A is a perspective view and FIG. 2B is a cross sectional view of a container in accordance with another aspect of this invention, which preferably functions as a gift bag;

FIGS. 3A and 3C are perspective views and FIG. 3B is a cross sectional view of a container in accordance with another aspect of this invention, which preferably functions as a gift box;

FIG. 4 is a perspective view of a compact disc sleeve in accordance with another aspect of this invention;

FIG. 5 is an exploded view of packaging according to another embodiment of the instant invention;

FIG. 6 is the completed packaging which is shown in exploded view in FIG. 5;

FIG. 7 is an exploded view of a composite work according to an embodiment of the instant invention.

FIG. 7A is a side view of the exploded view of the composite work of FIG. 7;

FIG. 8 is an exploded view of an alternate composite work according to an alternate embodiment of the instant invention;

FIG. 8A is a side view of the exploded composite work of FIG. 8;

FIGS. 9 and 9A show a method of assembling a composite work according to another embodiment of the instant invention; and,

FIG. 10 is a cross section through a panel of the bag of FIG. 2A showing a handle passing through an opening provided in the upper panel of a sidewall of the bag.

### DETAILED DESCRIPTION OF THE INVENTION

In accordance with this invention, a plastic substrate is used that has a two dimensional image and a three dimensional topography. The substrate is used to form at least part of, and preferably all of, a container. The container may be a gift box or a gift bag. Alternately, the container may be part or all of the packaging for a product. For example, the container may be a box or bubble packaging for a product. Alternately, the container may be a compact disc cover and/or sleeve. Providing a packaging or container for a product (or more generally an object such as a gift) with a three-dimensional relief and/or topographical texture thereon may enhance the attractiveness of the container, which may enhance the likelihood that it and/or the product may be purchased by a customer. Moreover, using a plastic substrate, such as thermoformable plastic, may enhance the durability of the container.

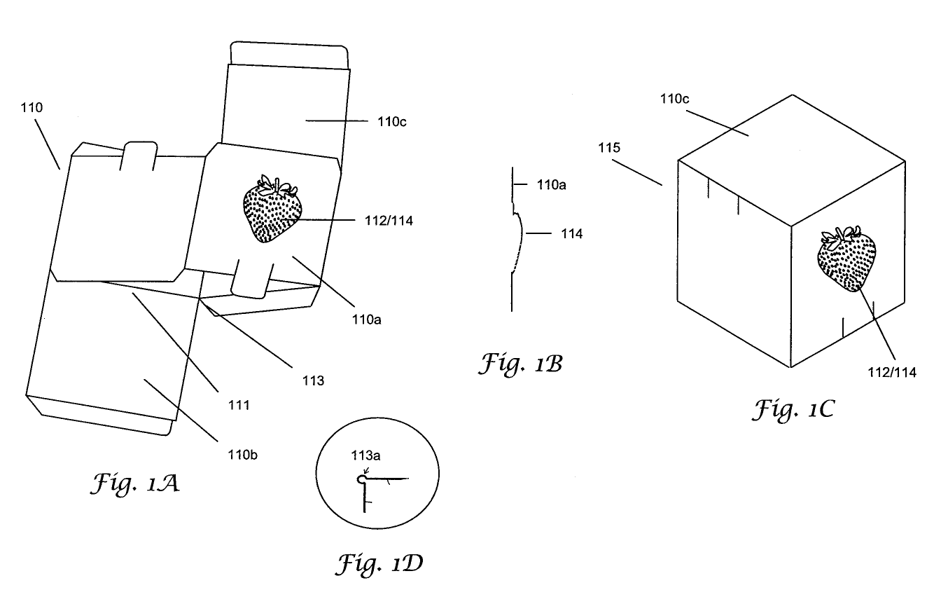

In one embodiment, as exemplified in FIGS. 1A and 1C, all or a portion of packaging 110, such as for a product and/or gift (e.g., a container) consists of or includes a plastic substrate with a three dimensional relief pattern corresponding to a two dimensional image. For example, one or more panel 110a, 110b, 110c may comprises a composite work 14. Alternately, one or more panel 110a, 110b, 110c may be formed from only the substrate, i.e. without any lining or backing substrate. It will also be appreciated that any portion or panel not made of a plastic substrate having a topography may be made from any materials known in the container art, such as a cellulose substrate.

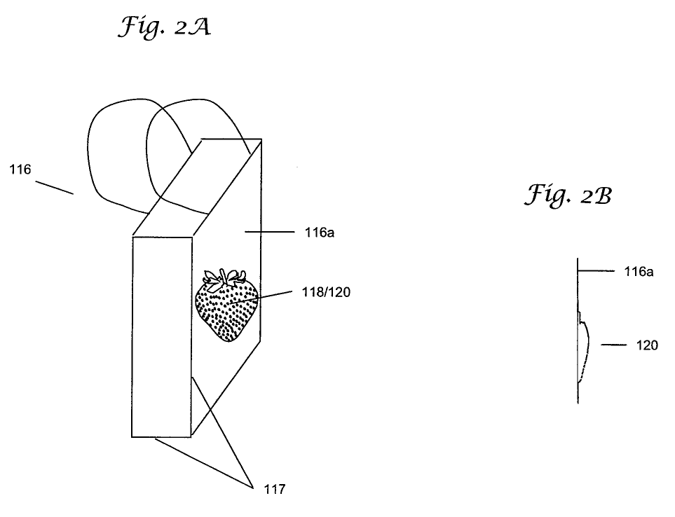

It will be appreciated that in some instances, such as a bag or the like, a handle 119 may be affixed or removably attached to one or more panel 116a. The type of handle 119 that is utilized may vary depending upon the type of bag. In one embodiment, the handle 119 may utilize a member that penetrates through the panel 116a of the bag 116. For example, handle 119 may comprise a rope, cord or other elongate member known in the bag art that passes through a panel 116a at least one and, preferably as exemplified in FIG. 2A, at least twice to form a loop. Typically, two such handles 117 are provided on opposed panels 116a. It will be appreciated that the handle may otherwise be secured to the bag 116, such as by forming the handle integrally therewith, e.g., forming it from the substrate, or by having an elongate member pass through a series of holes on more than one panel (e.g., through holes provided on opposed panels 116a) or by having the handle clamp onto one or more panels 116a.

In order to avoid an elongate member passing through the plastic substrate, a composite work 14 may be utilized. As shown in FIGS. 1 and 1A, composite work 14 comprises a plastic image substrate 18, which has an image bearing surface 20 and a rear surface 22, and a mounting substrate (preferably a cellulose substrate) 24, which has a mounting surface 26 and a viewable surface 28. Alternately, one or more mounting substrates may be used to secure two or more image substrates together.

The substrate is preferably a preferably a thermoformable plastic. The thermoformable plastic is preferably one or more of poly vinyl chloride (PVC), ethylene vinyl acetate (EVA), polystyrene, neoprene, polyethylene, ABS, PET, and, more preferably, is EVA, PVC or polystyrene and, most preferably, is polystyrene. One advantage of the use of neoprene is that neoprene may be reversibly deformable and, accordingly, can be reused in the process. If the substrate is an irreversibly deformable thermoplastic such as polystyrene, then the thermoformable plastic may be recycled by grinding the used substrate as is known in the art.

The plastic substrate may have a thickness from 0.002-0.100 inches, preferably from 0.003-0.025 inches, more preferably from 0.006-0.012 inches.

The portion of the substrate on which the image is provided, the image bearing portion, may be part or all of the substrate. The image may be a two-dimensional printed image (e.g., it may be an image which is printed by lithography or any other printing or image reproduction means known in the gift container and printing arts). The image may be provided on the substrate utilizing any method known in the art, including one or more of offset lithography, silk screening, spray coating, ink jet printing or dye simulation printing.

The substrate is treated or formed, preferably after the two dimensional image is printed on the substrate, to have a three-dimensional image or texture provided therein. This results in the production of a relief pattern or topography corresponding to part or all of the printed image thereby resulting in a three-dimensional image. The texturing of the substrate may be prepared by pressure forming, vacuum forming, pressure and vacuum forming, embossing, or applying a variable mechanical force to the substrate so as to produce a plurality of depths in the Z dimension. The variable mechanical force may be produced by a printing head, such as a dot matrix printing head, a daisy wheel printing head, by a plurality of pins or an eclectic deformable LCD whereby a computer signal will result in a physical member contacting and depressing the substrate at different locations. Preferably, the substrate is prepared by pressure and/or vacuum forming. It will be appreciated that the actual method by which the image and the topography are formed in the substrate does not comprise part of this invention and any such method known in the art may be utilized.

The image-bearing surface 20 of the substrate has an image provided therein. The image may be a two dimensional image, which may be prepared by printing an image on a thin plastic sheet. The topography may be prepared by preparing a mold that contains a female version of a three dimensional topography corresponding to the image and subjecting the substrate to vacuum and/or a pressure molding to form a male version of the topography in the substrate aligned with the two dimensional printed image. Preferably, image bearing surface 20 is prepared by printing a two dimensional image on image bearing surface 20 and then forming a three dimensional image (a relief pattern) matching the image printed on image bearing surface 20.

Prior to the substrate being subjected to any of the forgoing processes, the rigidity of the substrate may be temporarily reduced such as by increasing the temperature of the substrate or the addition of a chemical additive whose effect or presence is transient. For example, polystyrene, poly vinyl chloride or ABS may be exposed to methyl ethyl ketone (MEK). The MEK results in the thermo-formable plastic temporarily softening thereby enhancing the molding operation.

Such processes and substrates are described in co-pending U.S. patent application no. U.S. Utility patent application Ser. No. 11/571,323 and U.S. patent application Ser. No. 11/571,300, the disclosures of which are incorporated herein by reference.

It will also be appreciated that the image provided on the substrate need not be an artwork but may be of any design. For example, the image may be a design, e.g., an abstract design, photograph, machine produced art or reproduction for an advertisement, a movie poster, or a photographic likeness with three dimensional relief to more closely simulate real life.

Referring to FIG. 1A there is shown a perspective view of an exemplary embodiment wherein a container assembly 110 has at least one container surface or panel that is made of a plastic substrate. The container assembly 110 may be assembled in order to make a container 115 for various objects such as a product, gift and the like. Specifically, FIG. 1A illustrates a perspective view of an unassembled state of a container assembly 110 wherein one or more surfaces or panels of the container assembly 110 is made of a substrate. The plastic substrate used to make the one or more container surfaces of the container assembly 110 may be made using any method known in the art or described herein, and is preferably from thermoformable plastic.

In some embodiments, all surfaces or panels of the container assembly 110 are made from a plastic substrate. In such a case, the substrate has the shape of the entire container assembly 110 (e.g., an unassembled container box). In such a case, all of the panels of the container are preferably integrally formed (e.g., by being stamped or thermoformed from a single sheet of plastic). The panels may then be assembled (e.g., reconfigured by mechanically interlocking and/or with an adhesive) to form the container.

In other embodiments, only one or more surfaces of the container assembly 110 may comprise a plastic substrate having a textured image, and the remaining surfaces may be constructed from plastic that does not have a topography or different materials. In such a case, the substrate preferably has the shape of one or more surfaces of the container assembly 110, such as the substantially square surface 110a, and is then attached to the remaining surfaces using any means known in the art, such as using adhesive means. If two panels, which are secured together are plastic, they may be secured by heating or sonic welding. In either case, at least one surface of the container assembly 110 is made of a plastic substrate.

Referring back to FIG. 1A, container surface 110a made from a plastic substrate is provided with a substantially two-dimensional image 112, using any means known in the art and/or described above. Although the image 112 provided on the container surface 110a is shown on only one surface of the container assembly 110, it will be appreciated a substantially two-dimensional image 112 may be provided on more than one surface or optionally overlap more than one surface of the container assembly 110.

Container surface 110a is formed or treated to provide a three-dimensional relief or topographical texture 114 corresponding to the image 112 provided thereon, such that at least one specific feature of the image 112 provided on the container surface 110a varies in a third dimension orthogonal to the two dimensions of the image 112. That is, the topographical texture 114 provided in the container surface 110a aligns with the two-dimensional image 112 thereon, such that the texture 114 corresponds to at least one feature of the two-dimensional image 112.

For example, referring to FIG. 1A, there is shown a plan view of container surface 110a with a three-dimensional topographical texture 114 formed over the two-dimensional image 112 of a berry provided thereon. This is further shown in FIG. 1B, which illustrates a cross sectional view of the container surface 110a after the container surface 110a (made from the substrate) is provided with a three-dimensional topographical texture 114 corresponding to the two dimensional image of the berry 112 thereon. An example of a topographical texture is a three-dimensional shape of the berry. Moreover, additional three-dimensional textured details of the berry may also be provided in the substrate. For example the seeds of the berry on its skin (not shown) may be given a topographical texture to distinguish them from surrounding portions of the berry. Thus, the three dimensional topographical texture 114 may have a plurality of three-dimensional depths so as to simulate the real life texture and relief of the object portrayed in the image 112. Further, preferably, the scaling of the texture varies. For example, if the berry contains seeds, then the seeds may have a proportionately greater variation in the Z dimension then the berry itself. Accordingly, the ratio of the thickness of the seeds in the textured image compared to the actual thickness of a seed, may be greater than the thickness of the berry in the textured image compared to the actual thickness of a berry.

The design may be an actual object, such as a berry. The scale factor that is used for the length and width of the two dimensional reproduction of the object (i.e. the ratio of the length and width of an actual berry compared to the length and width of the image of the berry on the substrate) is preferably scaled at a different scale to the depth of the object (i.e. the ratio of the depth of an actual berry compared to the depth of the image of the berry on the substrate). For example, the depth of the textured reproduction in the Z dimension may be scaled at a substantially reduced scale compared to the scaling utilized for the X and Y dimensions. In such a case, the substrate has a bold appearance and will attract the attention of the person but will be able to be contained on a substrate.

As another example, the container surface 110a may be treated or formed such that only certain objects or aspects of the substantially two-dimensional image 112 have a corresponding three-dimensional topographical texture 114 provided therein, while the remaining portions of the image remain substantially two-dimensional. For example, the image provided on the substrate may be a human wearing a bathing suit and only the portion of the image depicting a bathing suit may have a corresponding three-dimensional topographical texture provided in the substrate (not shown). For example, the texture and natural shape of the bathing suit, such as the ripples in the bathing suit fabric and the curves of the underlying human body may be formed into the container surface 110a as the topographical texture while the rest of the container surface 110a (and by extension the image thereon) remains substantially two-dimensional.

Moreover, topographical texture 114 formed on the container surface 110a is not limited to corresponding to three-dimensional features of a two-dimensional image 112 and may correspond to any image, text, or design typically. However, for simplicity of explanation the topographical texture 114 is described in relation to three-dimensional features of a two-dimensional image 112.

It will be appreciated that any of the various methods and configurations known in the art and/or described herein for forming container surface 110a may be utilized. It will be appreciated that the printing and forming operations preferably occur prior to the panel or panels being formed, i.e., an expanse of the substrate is processed to produce the textured image and the panel(s) are then separated from the expanse of material.

The container assembly 110 may be assembled to provide a container 115 for an object. As shown in FIG. 1A, the container assembly 110 is divided into multiple container surfaces that are integrally formed together (e.g., by being cut from an expanse of the substrate) and which bend at dividing lines, such as dividing line 111, to form the container assembly 110. For example, container surface 110b may be bendable at dividing line 111, so that upon bending the container surface 110b may be configured so as to provide the bottom of the container 115 when assembled. Similarly, container surface 110c may also be bendable at a dividing line (not shown) so that upon bending, container surface 110c provides the top of the container 115, as is shown in FIG. 1C. The dividing lines, or more generally the substrate, may be bendable using any means known in the art. For example, the substrate may be scored, pre folded, or otherwise weakened (e.g., by being thinner) to produce dividing lines 111.

In some embodiments notches or tabs are utilized in a corner of a container surface, which may facilitate bending. Where a container surface made from a substrate has one edge that is integrally joined to another container surface at a dividing line and the two joined container surfaces are bendable at the dividing line, then a notch or tab may be created on either end of the dividing line (i.e. the corners of the container surface) to facilitate bending at the dividing line. For example, as exemplified in FIG. 1A, container surface 110b is integrally joined to another surface at dividing line 111. In some embodiments a notch or tab may optionally be created in one or more corners of such a container surface, such as corner 113. FIG. 1D illustrates an enlarged view of the alternative embodiment of corner 113a of container surface 110b with a notch created therein.

FIG. 1C illustrates a perspective view of a container 115 provided by the assembled container assembly 110. In the assembled state, the container assembly 110 is configured to create a container 115 having the shape of a box for receiving an object, such as a product and/or gift through an opening (e.g., openable top panel 110c). Upon a product and/or gift being inserted in the container 115, container 115 may be closed by bending top surface 110c along a dividing line 111, as shown in FIG. 1C, so that the product and/or gift is enclosed within container 115. As noted above, all of the container surfaces of the container assembly 110 may be integrally joined together at dividing lines such that the container assembly 110 is bendable at the dividing lines so that it may be assembled to provide the container 115. It will be appreciated that container 115 may be disassembled after assembly to return to the container assembly 110, such as for example, by re-bending the container surfaces at the dividing lines. Preferably, especially if the container 115 is a product container or gift box, the container 115 fully encloses a cavity and, more preferably, is reusable (i.e., it may be closed and opened without ripping or otherwise permanently breaking any panel or part thereof. Therefore, for example, top closure panel 110c may have a flap that is removably receivable into the cavity defined by container 115 and/or inter-engageable with one or more panels, as is known in the gift box art. It will be appreciated that container 115 may have more than six sides and that one or more of the side need not be planar to surround a cavity.

While the container 115 provided by the assembled container assembly 110 is shown as a box, it will be appreciated that the container 115 need not be a box but may be of any particular shape, such as a gift bag or storage medium case (e.g. compact disc or DVD sleeve), or a cylindrical tube (e.g., a gift bag for a bottle of wine in the form of a tube that may have one or more flaps to close the top of the tube). For example, FIGS. 2A and 2B illustrate an exemplary embodiment wherein a container assembly with at least one container surface made from a plastic substrate is assembled to provide a container having the shape of a bag. One or more optional handles 117 may be provided as shown

FIG. 2A illustrates a perspective view of a bag 116 (i.e., an assembled container assembly 110, not shown), wherein one or more surfaces of the bag 116 are made from a plastic substrate. For simplicity of explanation, at least surface 116a is made from a plastic substrate. The plastic substrate used to make at least surface 116a of bag 116 may be made according to any method known in the art or described herein, as is preferably made from thermoformable plastic.

As described above in relation to the box 115, the bag 116 surfaces may be integrally formed or secured together at dividing lines, such as dividing lines 117. A container assembly provides the bag 116 by bending the container assembly along the dividing lines 117. Further, assembly of the bag 116 may require securing one or more container surfaces together, using any securing means known in the art such as adhesive means. Moreover, if a container surface of the bag 116 has one edge that is integrally connected to another container surface, then a notch or tab may be created at one of both ends of the edge (i.e. at the corners of the container surface) so as to facilitate bending, as will be appreciated by those skilled in the art. It will be appreciated that a bag may be made from a single expanse of plastic substrate using any panel pattern known in the bag arts.

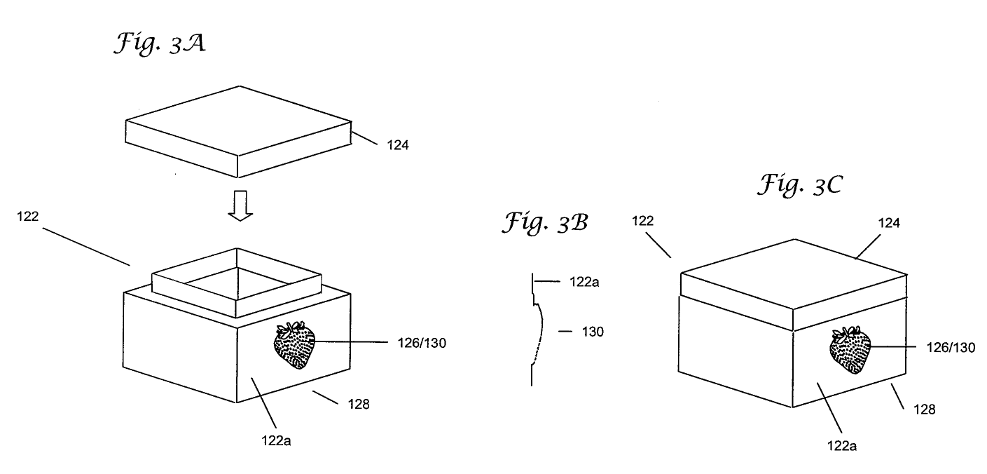

As another example, FIG. 3A illustrates an alternative embodiment of a box container 122 which has a top portion 124 (i.e. a separate openable lid) and a bottom portion 128, that when associated together, define a container assembly. The container assembly (and by extension the container 122) has one or more container surfaces made from a plastic substrate. For simplicity of explanation, at least of container surface 122a of top portion 124 and/or bottom portion 128 is made from a plastic substrate, which may be made according to any method known in the art or described herein, and is preferably made of thermoformable plastic. Moreover, it will be appreciated that one of the top portion 124 and the bottom portion 128 is configured to receive the other of the top portion 124 and the bottom portion 128. For example, the bottom portion 128 may have a recessed cube-shaped portion along its top having a smaller perimeter than the top portion 124, so that the top portion 124 surrounds the recessed cube-shaped portion when secured to the bottom portion 128 and rests along a lip created by the recessed cube-shaped portion. However, it will be appreciated that the top portion 124 may be removably received by bottom portion 128 using any suitable means known in the art, such as using mechanical locking means.

As described above, the surface 122a is provided with a substantially two-dimensional image 126 thereon and is formed to provide a three-dimensional topographical texture 130 aligned with the image 126. The topographical texture 130 is further shown in FIG. 3B which illustrates a cross sectional view of surface 122a. An object, such as a product or gift, may be inserted into the bottom portion 128 of container 122 and enclosed therein by securing the top portion 124, as is shown in FIG. 3C. The top portion 124 may be configured to be removably receivable on the bottom potion 128, so that the container 122 may be re-opened by removing the secured top portion 124. As above, the image 126 may be printed on surface 122a and topographical texture 130 may be formed over the image 126 using any means known in the art and/or described herein.

Although the image 126 and texture 130 is shown on only one face of the bottom portion 128 of the container 122, it will be appreciated that various other configurations are contemplated. For example, the image 126 and texture 130 could be provided on multiple faces of either the top portion 124 and/or bottom portion 128. Moreover, the object may be placed in the top portion 124 and then enclosed therein by securing the bottom portion 128 to the top portion 124. Moreover, multiple and different images, text, design, and the like may be provided on the various portions and/or surfaces of the container 122.

In accordance with a further aspect of the present invention a container provided by a container assembly with at least one surface made from a plastic substrate may not fully enclose a cavity. For example, the container may be tubular and open at one or both ends. An example of such a construction is a storage medium sleeve, such as a sleeve for a compact disc or DVD or for a gift, such as a bottle of wine. It will be appreciated that one end may be sealed, or sealable, such as a panel that is an extension of one side of the tubular container and is securable to another side of the container or a plurality of panels that may be interengageable and/or may be secured together by an adhesive. The adhesive may be applied to the panels and covered by a release layer which, when removed, exposes the adhesive layer on the panel to be used to close an end of the tube.

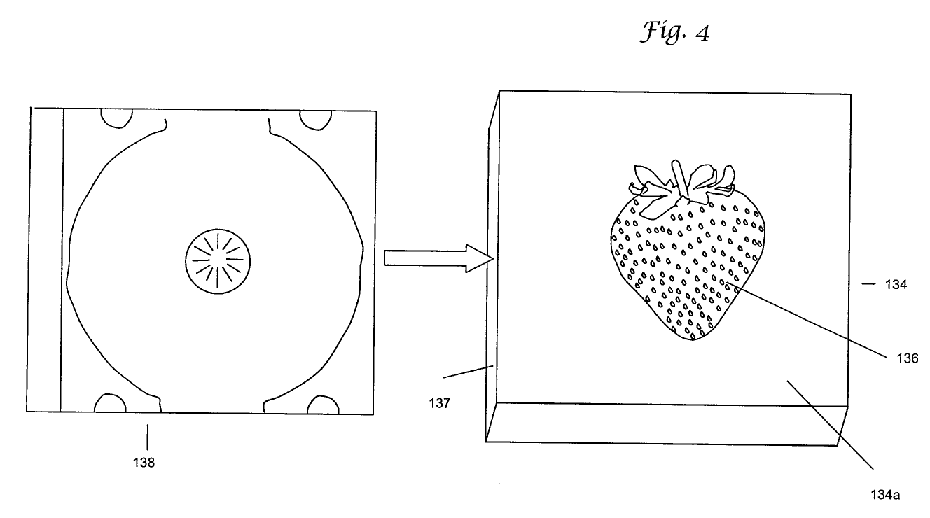

For example, FIG. 4 exemplifies a sleeve 134 for a compact disc case 138. At least surface 134a of the sleeve 134 is made from a substrate, with a textured image 136 provided thereon, using any means known in the art and/or described herein. The textured image 136 comprises a two-dimensional image (i.e. an image of a berry) and a three-dimensional topographical texture formed into the sleeve surface 134a, where the topographical texture corresponds to at least one feature of the image. The compact disc case 138 may then be inserted into the sleeve 134 via an opening 137, such that the sleeve 134 provides a container for the case 138. The entire sleeve may be made from a plastic substrate and may comprise multiple textured images 136. For example, the sleeve may be cut from a plastic blank and one surface or panel 134a may have a flap. The flap is secured to another surface 134a, e.g., the inner surface thereof, by an adhesive, welding or the like to define an assembled tubular container.

The sleeve 134 may take the shape of any compact disc or DVD cover, jacket or sleeve known in the art. Moreover, although the exemplary embodiment illustrated in FIG. 4 comprises a textured image 136, it is not limited to images, and it will be appreciated that a three-dimensional topographical texture may correspond to any image, text, design and/or material that is typically included on a compact disc or DVD cover and/or sleeve. Moreover, it will be appreciated that the sleeve 134 may be configured to provide a sleeve 134 for a compact disc or DVD case 138 or the compact disc or DVD itself.

In some embodiments, a backing layer or mounting substrate 24 may be affixed to the reverse side of the textured plastic substrate and/or the depressions in the reverse side filled to, e.g., provide additional container support or conceal the negative version of the textured image. The backing layer may be constructed from any suitable material, such as plastic, cardboard, paper mache or any other material described herein in relation to the mounting substrate. The backing layer is preferably formed from a plastic substrate.

The underlying backing layer may have substantially the same shape as the at least one container surface such that the container surface conceals substantially all of the backing layer and appears to unitarily provide the at least one container surface (or more generally the container) for the object, or may cover only part of the reverse surface (e.g., only the part with the texture provided therein). The backing layer, having the same shape as the container assembly may also have a plurality of surfaces connected by dividing lines, where the backing layer is also bendable at the dividing lines according to any suitable method known in the art. Therefore when the two are secured together and their corresponding surfaces are aligned, then the two together are still bendable at the overlapping dividing lines.

As another option, the backing layer may comprise a plurality of individual surfaces or panels that are not connected so that when the backing layer surfaces are secured to the plurality of integrally connected surfaces of the container assembly, an additional thickness in material (i.e. the thickness of the backing layer) is not created at the dividing lines of the container assembly, which may facilitate bending.

As a further option, where at least one container surface (e.g. surface 110b) and the underlying backing layer both have one corresponding edge that is integrally joined to another surface at a dividing line (e.g. dividing line 111) and the two joined surfaces are bendable at the dividing line, then a notch or tab (e.g. see notch at corner 113a in FIG. 1D) may be created on one or both ends of the dividing line (i.e., the corners of the container surface) in both the at least one container surface and the backing layer to facilitate bending at the dividing line, as will be appreciated by those skilled in the art.

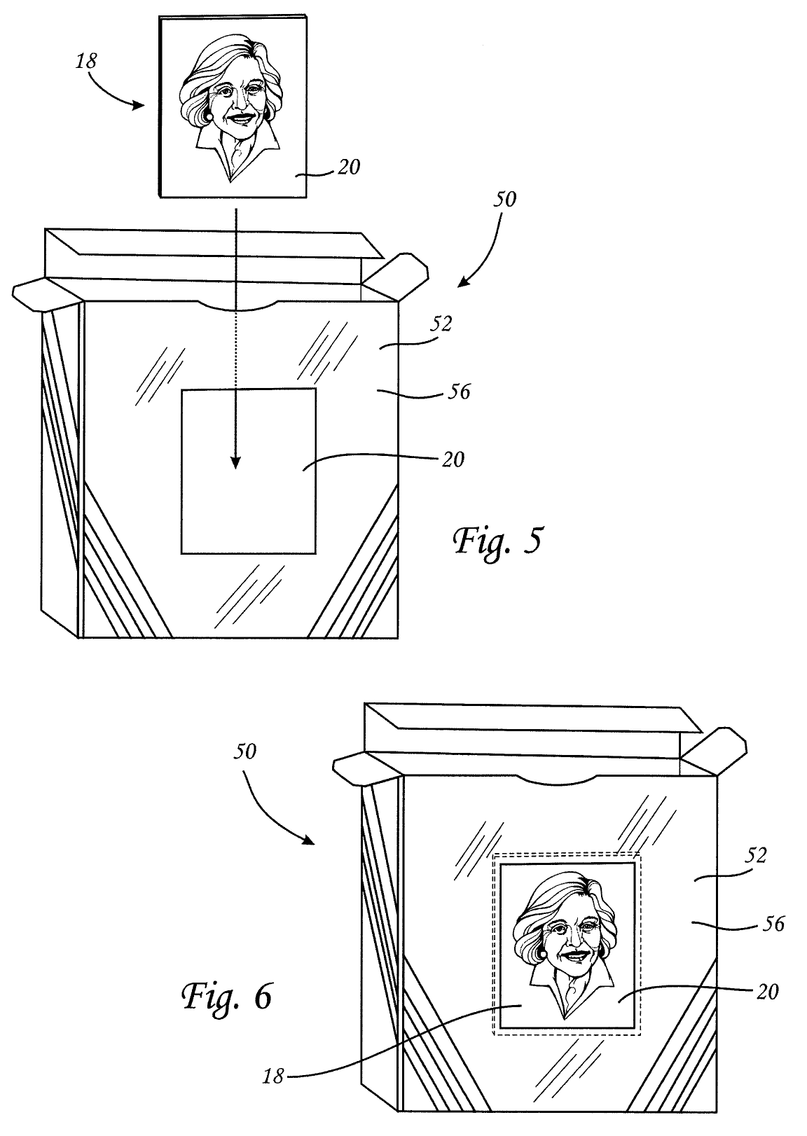

In other embodiments, the at least one container surface may have a different shape then the backing layer. For example, referring to FIGS. 5 and 6, packaging 50 includes a front panel 52 which may be a backing layer having a larger size than the substrate 18. The substrate 18 may be secured onto the front panel 52 (i.e., backing layer) so as to form at least one surface of packaging 50. Alternatively, the substrate 18 may have the same dimensions of the front panel 52 so that it conceals the whole front panel 52 and appears to be integrally incorporated into packaging 50 and unitarily make up the front panel 52.

Furthermore, at least one surface of the container may be made from a substrate that is transparent or partially translucent or transparent (e.g., a clear plastic) so that when an object is contained therein, a portion of the object (or all of the product) is visible through the substrate. Moreover, it will be appreciated that the above-described embodiments of containers are exemplary only, and the container, with at least one surface made using a substrate, may have the shape of any suitable container known in the art.

Optional mounting substrate 24 may be any material suitable for receiving image substrate 18, i.e., the substrate with the textured image 114. Mounting substrate 24 may be any substrate suitable for inclusion as a part or all of a container. Preferably, mounting substrate 24 is cellulose based and, more preferably, is paper or cardboard. It will be appreciated that mounting substrate 24 may be 8 to 100 pound weight paper or a paper mache. Preferably, mounting substrate 24 is cardboard or other rigid material suitable for use in packaging, such as plastic, e.g. Mylar.

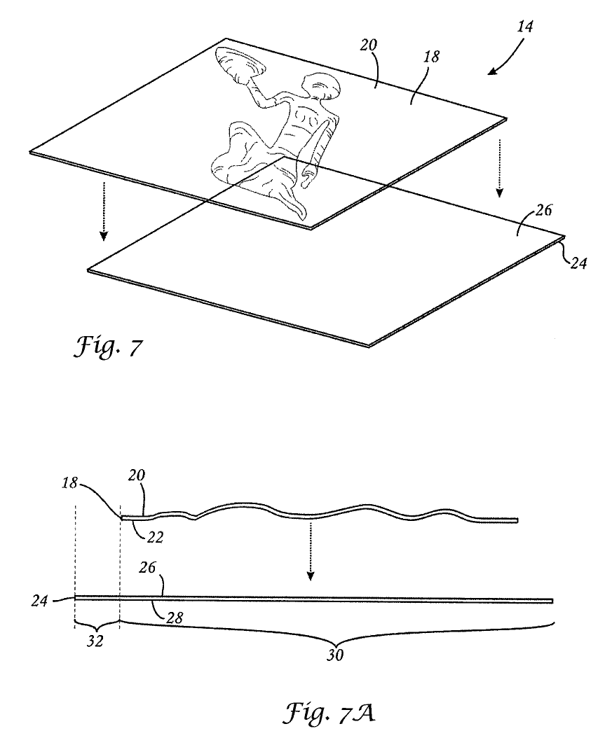

Mounting substrate 24 is preferably planar (i.e., the substrate extends in the X, Y planes) as shown in FIGS. 7 and 7A or it may be curved, and has a rear surface 28 which may have text or other material, e.g. a design, printed thereon in known fashion. Mounting surface 26 is secured to image substrate 18 by any means known in the art. For example, rear surface 22 of substrate 18 may be secured to mounting surface 26 such as by means of an adhesive, such as 3M Fastbond™ or a hot melt glue such as HB Fuller 1138™. In an alternate embodiment, it will be appreciated that rear surface 22 may be removably affixed to mounting surface 26 such as by means of a releasable adhesive, such as guar gum based adhesive.

In operation, each of image substrate 18 and mounting substrate 24 are preferably individually prepared. For example, a three dimensional image may be formed in image substrate 18 and text may be printed on viewable or rear surface 28 of mounting substrate 24. The substrates may then be associated together to form composite work 14 and composite work 14 may then be incorporated into a container. Alternately, it will be appreciated that image substrate may be secured to mounting substrate 24 after mounting substrate has been formed into a container.

It will be appreciated that mounting substrate 24 may have first and second portions 30, 32. First portion 30 is used to secure image substrate 18 to mounting substrate 24. Second portion 32, e.g., a flap, is used to secure mounting substrate 24 to another image or mounting substrate to the container, e.g., it may be used to glue or otherwise affix one panel of a container to another panel of a container.

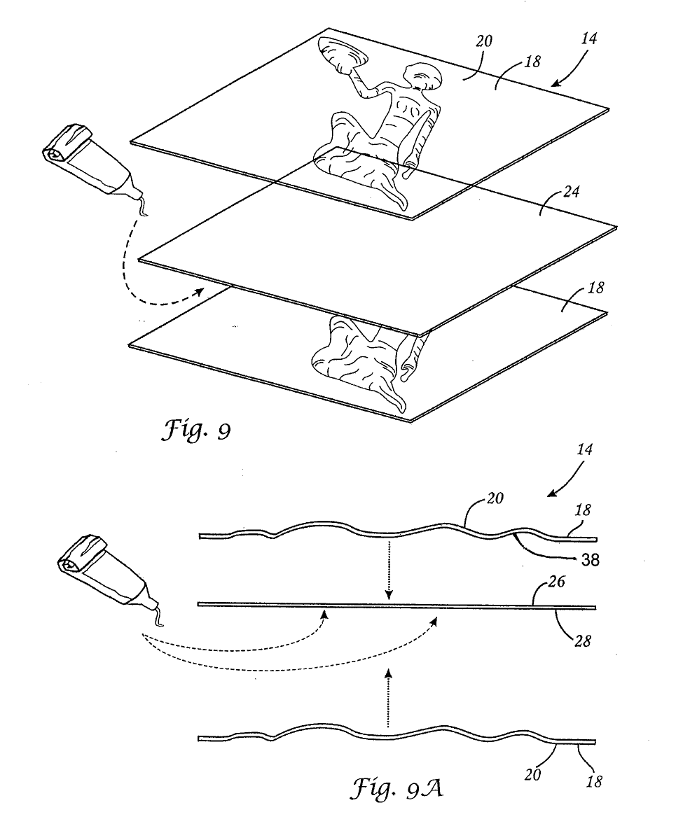

In an alternate embodiment, as exemplified in FIGS. 9 and 9A an image substrate 18 may be affixed to each of the opposed surfaces 26, 28 of mounting substrate 24. Thus composite work 14 may have two image bearing surfaces 20 that are essentially mounted back to back so as to provide a three dimensional image on both the inside and outside surface or one or more portions of a container.

Due to the forming process, depressions 38 are formed in rear surface 22 of image substrate 18 (see FIG. 9A). These depressions form the negative image of the topography formed in image bearing surface 20. In order to enhance the durability of image substrate 18, depressions 38 may be filled, such as by filling depressions 38 with plaster, silicone, epoxy, or other, preferably non shrinking, filler materials. Accordingly, essentially no hollow spaces may be provided between rear surface 22 of image substrate 18 and a mounting substrate 24. It will be appreciated that in a particularly preferred embodiment, depressions 38 may be filled and cover sheet 36 may be provided. It will be appreciated that these options may be used singularly or in combination with any embodiment set out herein and with any embodiment.

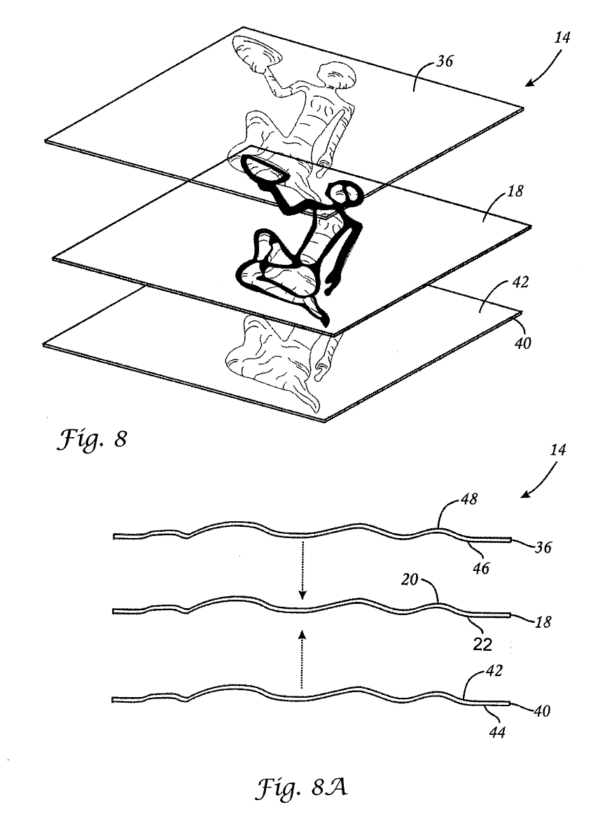

A further alternate embodiment is shown in FIGS. 8 and 8A. In FIGS. 8 and 8A, mounting substrate 18 is provided with both a cover sheet 36 having a mounting surface 46, for being secured to image bearing surface 20 of image substrate 18, and a top surface 48 and with a bottom sheet 40 having a mounting surface 42, for being secured to rear surface 22 of image substrate 18, and a rear surface 44. Optional cover sheet 36 may also be utilized on only one side of image substrate 18.

As image substrate 18 may be provided on an exterior surface, cover sheet 36 may be provided to enhance the durability of image substrate 18. For example, cover sheet 36 may be a thin plastic sheet (i.e. it may have the same thickness as image substrate 18 or it may be thinner) and be secured over image substrate 18 by any means known in the art. As shown in FIG. 8A, cover sheet 36 may have the same profile or topography formed therein as is formed in image substrate 18. It will be appreciated that if image substrate 18 has a relatively low profile, or if sheet 36 is sufficiently thin and/or elastic, then cover sheet 36 need not be subjected to any pre-treatment steps to provide a three-dimensional image therein but may merely be applied over image bearing surface 20 and conform to the topography of image bearing surface 20 as it is applied.

Bottom sheet 40, if provided, may be secured or releasably secured to mounting sheet 18 by the same means used for cover sheet 36 or by a different means. As shown in FIG. 8A, bottom sheet 40 optionally also has the same image formed in it as image substrate 18 and as cover sheet 36. Accordingly, mounting surface 42 and rear surface 22 of image substrate 18 are in intimate contact. Preferably, each of cover sheet 36 and bottom sheet 40 form a material that can provide additional dimensional stability to image substrate 18. Accordingly, the composite work 14 shown in FIGS. 8 and 8A may be used in any application disclosed herein and, accordingly, may be secured to mounting substrate 24.

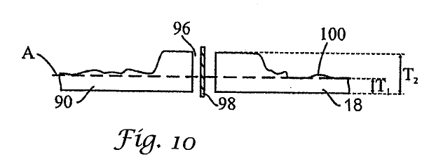

In an alternate embodiment, a handle 119 or other carry member is affixed to the substrate 18. In such a case, substrate 18 is preferably configured so as to enable the elongate member to pass therethrough while reducing the likelihood of the substrate tearing or fracturing. Accordingly, the substrate may be provided with holes or openings 96 through which an elongate member, such as carry member 98, may extend (see FIG. 10). Such openings are preferably configured so that there is not an angle over 5°. It would be appreciated that holes 96 need not be circular. Accordingly, while holes 96 may be circular or oval, they may merely be radiused so as to have a continuous perimeter.

By providing holes that are preformed in the substrate, the substrate need not be pierced during the installation of the carry member. Instead, during the operation, substrate 18 may merely be preformed so that the elongate member can be passed therethrough. It will be appreciated that holes 96 may be provided in substrate 18 when the rigidity of substrate 90 has been temporarily reduced, such as by heating or chemical treatment with, e.g. methyl ethyl ketone. It will also be appreciated that holes 96 may be formed during the manufacturing process.

Alternately, or in addition, substrate 18 may have an increased thickness in the vicinity of hole 96. For example, as shown in FIG. 10, substrate 18 generally extends along plane A. It will be appreciated that the actual thickness may vary if substrate 18 is provided with a three-dimensional image or topography 100 formed therein. Distal to hole 96, substrate 18 has a thickness of about T1. However, adjacent hole 96, the thickness of substrate 18 has been increased to T2. Accordingly, the image-bearing surface of substrate 18 extends out of plane A adjacent the perimeter of opening or hole 96. It will be appreciated that only one, or each, opposed surface of substrate 18 may be configured to extend out of plane A.

Although the substrates are generally described herein as being flat, i.e. extending only in the X and Y dimensions, it will be appreciated that one or more panels or portions may be curved or of an alternate configuration. In such embodiments, the three-dimensional topographical texture formed therein may then vary orthogonal to a line tangent to the substrate at a given position, as will be understood by those skilled in the art.

It will be appreciated that various modifications and additions may be made to the embodiments disclosed herein and each are in the scope of the following claims. It will be appreciated that any of the embodiments set out herein, or preferences for any embodiments, may be used in conjunction with any other embodiment or optional preferences.

1. A container assembly comprising:
(a) a plastic substrate, at least a portion of which has a textured image, the textured image comprising:
(i) a substantially two dimensional image; and,
(ii) a topographical texture aligned with the two dimensional image wherein the topographical texture corresponds to at least one feature of the two dimensional image;
wherein the container assembly is configured for assembly to provide a container.

2. The container assembly as defined in claim 1 wherein the substrate comprises a thermoformable plastic.

3. The container assembly as defined in claim 1 wherein the substrate is one or more of poly vinyl chloride, ethylene vinyl acetate, polystyrene, neoprene, polyethylene, ABS, and PET.

4. The container assembly as defined in claim 1 wherein the substrate is molded to provide the topographical texture.

5. The container assembly as defined in claim 3 wherein the substrate defines a plurality of panels that, when assembled, provide a container having a cavity.

6. The container assembly of claim 3 wherein the cavity is sized to receive a storage medium case.

7. The container assembly of claim 3 wherein the cavity is enclosed on all sides by the substrate.

8. The container assembly as defined in claim 7 wherein the cavity has an opening that is reversibly closeable by at least one of the panels.

9. The container assembly as defined in claim 8 wherein the container is a box having an openable lid.

10. The container assembly as defined in claim 5 wherein the container comprises a bottom container portion, and an openable lid that is removably receivable on the bottom container portion.

11. The container assembly as defined in claim 5 wherein the plurality of panels are integrally joined together.

12. The container assembly as defined in claim 11 wherein the plurality of panels are bendable about dividing lines provided in the substrate.

13. The container assembly as defined in claim 1 wherein the container is a bag.

14. The container assembly as defined in claim 1 wherein all of the container is formed from the plastic substrate.

15. The container assembly as defined in claim 1 wherein the container is a tubular container.

16. The container assembly as defined in claim 15 wherein the tubular container is a storage medium sleeve.

17. The container assembly as defined in claim 1 wherein the at least one container surface comprises an image side bearing the textured image and a reverse side and the reverse side has a backing layer affixed thereto.

18. A method for producing a container assembly comprising:
a) providing a plastic substrate having at least one container surface;
b) providing a substantially two dimensional image on the at least one container surface; and,
c) providing a topographical texture corresponding to at least one feature of the substantially two-dimensional image, such that the at least one feature of the image varies in a third dimension, orthogonal to the two dimensions of the image.
wherein the container assembly is configured for assembly to provide a container.

19. The method as defined in claim 18 wherein the at least one container surface is made of a deformable material, and step (c) comprises molding the deformable material to provide the topographical texture.

20. The method as defined in claim 18 further comprising providing a substrate that is made of thermoformable plastic as the substrate.

21. The method as defined in claim 20 further comprising providing the topographical texture by molding the substrate.

22. The method as defined in claim 18 wherein the substrate comprises an image side bearing the two dimensional image and a reverse side, and the method further comprises providing a backing layer on the reverse side.
